(19) United States
(12) Patent Application Publication
(10) Pub. No.: US 2004/0189809 A1
(43) Pub. Date: Sep. 30, 2004

(54) Digital imaging apparatus and method for selecting data transfer mode of the same

(76) Inventor: Juang-hwan Choi, Suwon-city (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/790,780

(22) Filed: Mar. 3, 2004

(30) Foreign Application Priority Data
Mar. 27, 2003 (KR) 2003-19252
Apr. 30, 2003 (KR) 2003-27797

(51) Int. Cl. H04N 5/225

(52) U.S. Cl. 348/207.1

(57) ABSTRACT

A digital imaging apparatus and a method for selecting a data transfer mode thereof is disclosed. The digital imaging apparatus comprises a main storage unit for storing a firmware for at least two data transfer modes for transmitting image data acquired through a camera to an external device in different manners, respectively, and also storing a descriptor including information for identifying the firmware, a mode selection unit for outputting a mode selection signal for a certain transfer mode for the at least two data transfer modes, a transmitting module for connecting to the external device to transmit the image data to the external device, the transmitting module sending the image data in different data transfer manners for each data transfer mode, and a controlling unit which controls the transmitting module so as to set the transfer type corresponding to the selected certain transfer mode if the mode selection signal is received from the mode selection unit, and reads out descriptor of firmware corresponding to the selected transfer mode from the main storage unit and provides the descriptor to the transmitting module if the transmitting module is connected to the external device. Therefore, the digital imaging apparatus can efficiently perform communications with the external device by selecting a mode for execution before being connected to the external device.

### CROSS-REFERENCE TO RELATED APPLICATIONS

This application claims the benefit of Korean Patent Application No. 2003-19252 filed Mar. 27, 2003 and Korean Patent Application No. 2003-27797, filed Apr. 30, 2003, in the Korean Intellectual Property Office, the disclosures of both are incorporated herein by reference.

### BACKGROUND

1. Field of the invention

The present invention generally relates to a digital imaging apparatus and a method for selecting data transfer mode of the same, and more particularly to a digital imaging apparatus capable of smoothly performing data communication with a computer by selecting the data transfer mode for communicating with the computer and then being connected to the computer via a universal serial bus (hereinafter; to be referred to “USB) interface and a method for selecting data transfer mode of the same.

2. Brief description of the related art

A digital imaging apparatus such as digital video camera (DVC) converts the optical signal of an object into an electric signal using a charged coupled device (CCD), and then converts the analog electrical signal into a digitized signal. The image that is recorded and reproduced by the digital signal is generally of high quality without the image quality being substantially degraded.

Recent innovations provided by the digital imaging apparatus is the ability to perform fast data communications with external digital equipment (for example, PC provided with Windows Explorer® available from Microsoft® corporation) via a USB interface, without corrupting the digital signal.

In order to carry out data transmission between the digital imaging apparatus and PC, the digital imaging apparatus transmits the digital image data to PC with the USB interface. A user of the PC can then easily edit the transmitted image data using edit software installed in the PC.

Existing digital imaging apparatus, however, also provide the following two modes of data transfer in addition to the USB interface. One is a real-time streaming mode, wherein the image data being currently is transmitted to the PC on a real-time basis, and then the acquired image data can be displayed on the PC's display device. The other is a mass storage mode, wherein the previously acquired, digitized and recorded image data is transmitted to the PC.

In order to implement the two modes above, the digital imaging apparatus incorporates firmware for the real-time streaming mode and/or the mass storage mode, and the PC includes one or more software drivers for driving the respective modes. In a conventional digital imaging apparatus which incorporates the firmware the digital imaging apparatus carries out one of the two modes, using the incorporated firmware with a run command for the certain mode from PC connected via USB interface,.

with a problem can arise when using the conventional digital imaging apparatus which incorporates the firmware for both of the two modes. If the conventional digital imaging apparatus is connected to PC under the condition that the mode to be carried out is not previously selected, the conventional digital imaging apparatus cannot smoothly perform data communications with PC. This is because the conventional digital imaging apparatus does not select and notify the PC of the driving mode, so that the PC cannot determine which driver of the firmware to put on stand-by. In addition, even if the apparatus receives the run command for a specific mode from the PC, the conventional digital imaging apparatus cannot determine which firmware of the incorporated firmware it has to access and carry out the function for the selected mode.

### SUMMARY

The present invention has been made in order to solve the foregoing problems described above. Accordingly, it is one aspect of the present invention to provide a digital imaging apparatus capable of smoothly performing data communications with a computer by selecting one communication mode in advance, among at least two modes. In the first mode the image data currently being acquired is sent to the PC on a real-time basis, and mode in the second. The previously acquired and stored image data is sent to the PC. A method for selecting one of the two data transfer modes.

In order to achieve the aforementioned aspects and/or other features of the embodiments of the present invention, a digital imaging apparatus is provided which comprises: a main storage unit for storing firmware for at least two data transfer modes for transmitting image data acquired through a camera to an external device in at least two different methods, respectively, and also storing a descriptor which includes information for identifying the firmware, a mode selection unit to output a mode selection signal for a certain transfer mode of the at least two data transfer modes, and a transmitting module for connecting to the external device to transmit the image data to the external device, wherein the transmitting module sends the image data in different data transfer manners for the each data transfer mode. The digital image apparatus further includes a controlling unit which controls the transmitting module so as to set the transfer type corresponding to the selected certain transfer mode if the mode selection signal is received from the mode selection unit, and reads out the descriptor of the firmware corresponding to the selected transfer mode from the main storage unit and provides the descriptor information to the transmitting module if the transmitting module is connected to the external device. The controlling unit allows the read descriptor of the firmware to transmit if a transfer allowance command is received from the external device.

Further provided is a sub-storage unit for storing the image data acquired through the camera. The two data transfer modes includes a first mode, wherein the image data being currently acquired through the camera is transmitted to the external device in a real-time data stream, and a second mode wherein the image data stored in the sub-storage unit is transmitted to the external device. The main storage unit stores each of the firmware corresponding to the first mode and the second mode and the identifying information.

Also further provided is an on screen display (OSD) processing unit that OSD-processes a data transfer mode selection screen, for selecting the transfer mode from either the first mode or the second mode, and outputs the result of the process; a display unit for displaying the OSD processed data transfer mode selection screen, and a display request unit for transmitting display request signal on the data transfer mode selection screen. If the display request signal is received from the display request unit, the controlling unit OSD-processes and displays the data transfer mode selection screen on the display unit, and receives the mode selection signal for the transfer mode selected by the mode selection unit of the displayed data transfer mode selection screen.

The transmitting module according to an embodiment of the present invention comprises: a FIFO which is divided into a plurality of temporal storage areas, in which the image data to be sent to the external device and the descriptor corresponding to the selected transfer mode are temporally stored, a provision unit for providing a plurality of endpoints corresponding to the plurality of temporal storage areas, and a communication controller that selects at least three endpoints out of the plurality of the endpoints, and sets the transfer manner for transferring the image data for each of the selected endpoints. Selection of the endpoints and transfer manner by the communication controller allows the image data temporally stored in the temporary storage areas corresponding to the selected endpoint to be sent to the external device according to the transfer type set.

If the first mode is selected by the mode selection unit, the communication controller selects endpoint Nos. 0 to 2 among the plurality of endpoints, and if the second mode is selected by the mode selection unit, the communication controller selects endpoints Nos. 0, 2, and 3.

Simultaneously, the communication controller sets the transfer manner for each of the selected endpoints.

The transmitting module according to an embodiment of the present invention is a universal serial bus interface, and the identifying information of the firmware is stored in the location of offset 10 of the descriptor, with a data storage size of two bytes. If the external device and the transmitting module are connected with each other, the sub storage unit is recognized as an accessible movable disc in the external device.

According to an embodiment of the present invention, a method for selecting data transfer mode of a digital imaging apparatus comprises the steps of storing image data acquired by a camera, selecting a certain mode from at least two modes for transferring the image data acquired by the camera to an external device by different methods, and connecting the digital imaging apparatus to the external device via a transmitting module so as to communicate with the external device after the certain transfer mode is selected. The method for selecting a data transfer mode further comprises receiving a transfer allowance command in a descriptor data word from the external device, and transferring the descriptor, including identifying information of firmware corresponding to the selected transfer mode, to the external device.

Prior to the step of selecting the certain transfer mode, transmitting a display request command for a data transfer mode selection screen, which makes selectable the transfer mode from the at least two modes, and if the display request command is output, processing the data transfer mode selection screen by the OSD, and thereby displaying the OSD processed data transfer mode selection screen. The step of selecting the certain transfer mode selects the certain transfer mode from the OSD processed data transfer mode selection screen.

The at least two data transfer modes include a first mode wherein the image data being currently acquired by the camera is transferred to the external device in a real-time data stream, and a second mode wherein the image data stored in the storage step is transferred to the external device. The firmware and the descriptor corresponding to the first mode and the second mode are stored.

Following the step of selecting the certain transfer mode, the method for selecting a data transfer mode further comprises selecting at least three endpoints for transferring image data corresponding to the selected transfer modes, setting the transfer type for transferring the image data for each of the selected three endpoints, and transferring the descriptor corresponding to the selected transfer mode to the external device after connecting to the external device. The method further comprises receiving a run command on the selected transfer mode from the external device, dividing the image data into a prescribed packet size and temporally storing the divided image data in three temporal storage areas corresponding to the selected three endpoints, and transferring the temporally stored image data to the external device according to the set transfer type.

In the endpoint selection step, if the first mode is selected in the mode selection step, endpoints Nos. 0 to 2 are selected and if the second mode is selected, endpoints Nos. 0, 2 and 3 are selected.

According to an embodiment of the present invention, a digital imaging apparatus for transferring image data being picked up through a camera to external device connected via a transmitting module, includes: a sub-storage unit for storing the image data being picked up through the camera, and a main storage unit for storing a firmware for a first mode wherein the image data being acquired through the camera is sent to the external device in a real-time stream and a firmware for a second mode wherein the image data stored in the sub-storage unit is sent to the external device. The digital imaging apparatus also comprises a mode selection unit for applying a mode selection signal for a certain transfer mode of the first mode and the second mode, and a controlling unit that allows identifying information of firmware corresponding to the selected certain mode to be transferred to the external device, if the mode selection signal is received from the mode selection unit and the transmitting module is connected to the external device.

Further provided in the digital imaging apparatus are an OSD processing unit for OSD-processing the data transfer mode selection screen for selecting the certain transfer mode of the first mode and the second mode and forwarding the results of OSD-processing, a display unit for displaying the OSD processed data transfer mode selection screen, and a display request unit for forwarding the display request signal on the data transfer mode selection screen. If the display request signal is received from the display request unit, the controlling unit OSD processes and displays the data transfer mode selection screen on the display unit, and the mode selection unit outputs the mode selection signal to the controlling unit by selecting the certain mode of the data transfer mode selection screen displayed on the display unit.

If the identifying information of the firmware is transferred to the external device and the execution command for the selected certain mode is received from the external device, the controlling unit allows the firmware corresponding to the selected certain mode to be executed.

The transmitting module is provided with a universal serial bus interface. If the external device and the transmitting module are connected with each other, the sub-storage unit is recognized as an accessible movable disc in the external device.

Further, according to an embodiment of the present invention, a method for selecting the data transfer mode of a digital imaging apparatus transferring image data being acquired through a camera to an external device connected via a transmitting module comprises the steps of storing the image data being acquired through the camera, selecting a certain mode among a first mode, wherein the image data being acquired through the camera is send to the external device in a real-time data streaming and a second mode wherein the image data that is stored in advance is sent to the external device, and if the certain mode is selected and the external device and the transmitting module are connected with each other to perform data communication, transferring the identifying information of firmware corresponding to the selected certain mode to the external device.

Prior to the step of selecting the certain mode, the method for selecting the data transfer mode further comprises transmitting a display request command for a data transfer mode selection screen, making selectable the certain mode of the first mode and the second mode, and if the display request command is output, OSD-processing the data transfer mode selection screen, thereby displaying the OSD-processed data transfer mode selection screen. The step of selecting the certain mode selects the certain mode from the OSD-processed data transfer mode selection screen.

After the step of transferring the identifying information of the firmware to the external device, the method for selecting the data transfer mode further comprises receiving the execution command for the selected certain mode from the external device, and executing the firmware corresponding to the selected certain mode.

### BRIEF DESCRIPTION OF THE DRAWINGS

The embodiments of the present invention will be explained with reference to the accompanying drawings, in which:

FIG. 1 is a schematic block diagram showing a digital imaging apparatus according to a preferred embodiment of the present invention;

FIGS. 2A, 2B and 2C are views of an embodiment of a descriptor stored in the firmware storage unit shown in FIG. 1;

FIG. 3 is a view of a data transfer mode selection screen displayed by the OSD processing unit shown in FIG. 1 in accordance with an embodiment of the invention;

FIG. 4 is a schematic block diagram of the USB transmitting module shown in FIG. 1; and

FIG. 5 is a flow chart illustrating a method for a data transfer mode selection using the digital imaging apparatus shown in FIG. 1.

### DETAILED DESCRIPTION OF THE PREFERRED EMBODIMENTS

The above objects and other features and advantages of the present invention will be better understood from the following description taken in conjunction with the attached drawings.

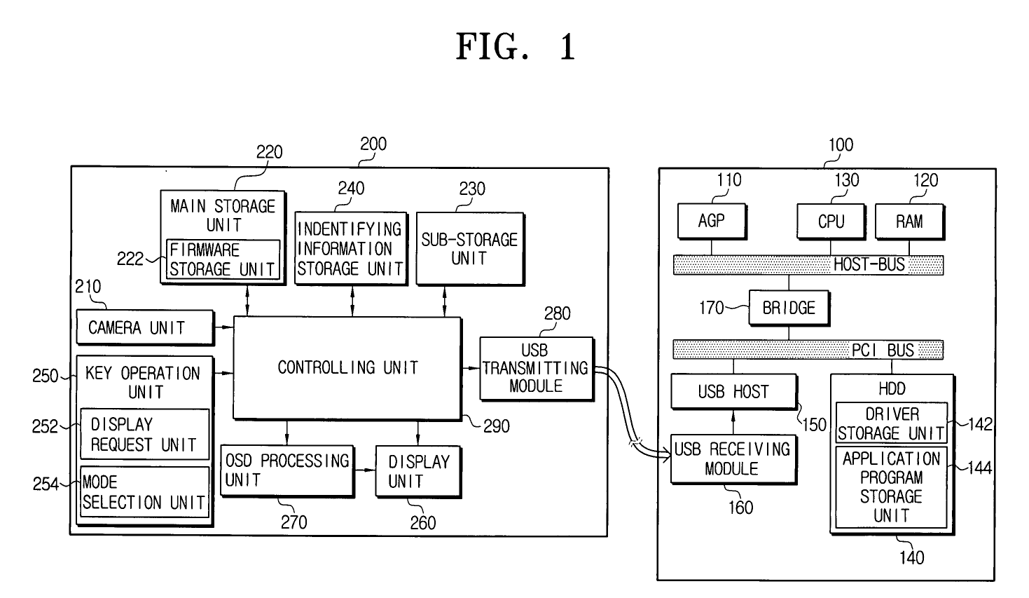

FIG. 1 is a schematic block diagram showing digital imaging apparatus according to a preferred embodiment of the present invention.

With reference to FIG. 1, a PC 100 is employed as an external piece of equipment to the digital imaging apparatus 200, which, according to an embodiment of the present invention, supports USB communication capable of transmitting data at a high speed, and are connected via USB transmission cable 300. The digital imaging apparatus 200 transmits image data to the PC 100 via USB transmission cable 300, and the PC performs functions such as storage, editing, and playback of the image data transmitted from the digital imaging apparatus 200, among other functions, using any one of a number of application programs.

The PC 100 connected to the digital imaging apparatus 200 comprises an advanced graphics port (AGP) 110, RAM 120 and CPU 130 that are connected to host bus. The PC1OO further comprise a hard disk drive (HDD) 140, a USB host 150 and a USB receiving module 160 that are connected to a PCI bus.

A bridge 170 is further included in PC100 for synchronizing clocks between the host bus and PCI bus the bridge 170 controls general data transmission, such as, data transmission associated with RAM 120 and CPU 130, data transmission between RAM 120 and HDD 140, and video data transmission associated with AGP 110. The RAM 120 stores programs that are loaded from HDD 140 to be implemented by CPU 130 and also stores the resulting data processed by CPU 130.

The HDD 140 stores operation system (OS) software, and in this embodiment, the HDD 140 stores a window-based operation system available from Microsoft Corporation. The HDD 140 also includes a driver storage unit 142, and an application program storage unit 144. The driver storage unit 142 stores a real-time streaming driver and a mass storage driver for performing functions provided by the digital imaging apparatus 200. The real-time streaming driver and the mass storage driver are a driving program for driving a real-time streaming mode and a mass storage mode, both of which are described below in greater detail. The application program storage unit 144 stores various programs including application program matching the real-time streaming driver. The USB host 150 receives digital signals from the digital imaging apparatus 200 connected via USB receiving module 160. The digital imaging apparatus 200 according to a preferred embodiment of the present invention comprises a camera unit 210, a main storage unit 220, a sub-storage unit 230, an identifying information storage unit 240, a key operation unit 250, a display unit 260, an OSD processing unit 270, a USB transmitting module 280, and a controlling unit 290.

The camera unit 210 converts the optical signal of the object that impinges upon the charged coupled device (not shown) into an analog electric signal. The camera unit 210 the digitizes the analog electric image signal, as well as the sound signal recorded through a microphone (not shown).

Hereinafter, the digitized signal composed of the image signal or the sound signal output from the camera unit 210 is collectively referred to as image data. The image data output from the camera unit 210 is selectively stored in the sub-storage unit 230, or is provided to the PC 100 via USB transmitting module 280.

The main storage unit 220 is a non-volatile memory such as ROM, and stores control program for driving the general operation of the digital imaging apparatus 200. In addition, the main storage unit 220 includes a firmware storage unit 222. The firmware storage unit 222 stores separate firmware for at least two image data transfer modes supported by the digital imaging apparatus 200 and a descriptor for each firmware.

The at least two image data transfer modes are the modes wherein the image data being acquired through the camera unit 210 is transmitted to PC 100. The image data transfer modes are of different types, and a description will be made below regarding the real-time streaming mode and the mass storage mode. Therefore, the firmware storage unit 222 stores firmware that supports the real-time streaming mode and firmware for supporting the mass storage mode.

The real-time streaming mode (first mode) employed is a data transfer mode that allows the image data being currently acquired through the camera unit 210 to be transmitted to PC 100 in a real-time. The acquired image data can then be displayed on the display device (not shown) of PC 100.

The mass storage mode employed as the second mode is a data transfer mode that allows at least one file selected by the PC 100 from among a plurality of files that have been previously acquired through the camera unit 210 and is stored in the sub storage unit 230, to be transmitted to PC 100. The transmitted file is thereby stored in PC 100.

Each firmware stored in the firmware storage unit 222 has an identifying information (ID). The firmware storage unit 222 stores the descriptor for the each firmware. Thus, the number of the stored descriptor corresponds to that of firmware stored in the firmware storage unit 222.

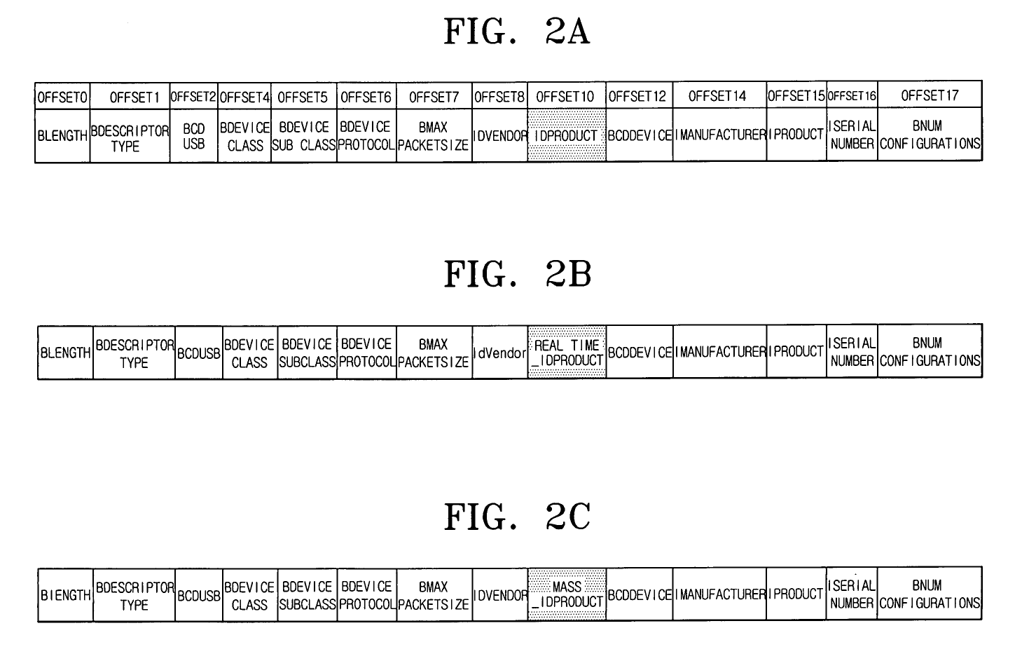

Typically, in a USB system, the descriptor usually refers to device information for a USB device, and has the data structure shown in FIG. 2A formatted according to a known USB standard. The device descriptor shown in FIG. 2A and data transmission associated with USB to be described below are known USB specifications, and therefore, the description thereof will be omitted.

In the embodiments of the present invention, however, the identifying information for the firmware stored in the firmware storage unit 222 is written in an IdProduct (PID) field. It can be seen that the PID field is located at offset 10, and the identifying information is stored in two data bytes.

By storing the descriptor for each firmware, the descriptors for the real-time streaming firmware and the mass storage firmware are stored in the firmware storage unit 222 in the data structures as shown in FIGS. 2B and 2C. In particular, with reference to FIGS. 2B and 2C, it can be seen that the identifying information for the real-time streaming firmware is written in the real-time_PID field (FIG. 2B), and the identifying information for the mass storage firmware is written in the mass_PID field (FIG. 2C).

The sub-storage unit 230, which can be implemented as a flash memory, stores the image data output from the camera unit 210 under the database state. The image data stored in the sub-storage unit 230 can be implemented as either a moving picture or a still image photograph by PC 100, or the digital imaging apparatus 200.

In the case when the digital imaging apparatus 200 is connected to the PC 100 to run Windows Explorer, CPU 130 of PC 100 recognizes the sub storage unit 230 as a mass storage class device. The sub-storage unit 230 is recognized as a movable disc by Window Explorer installed in PC 100. Accordingly, the sub-storage unit 230 can smoothly carry out data communications with PC 100 by using, for example, a memory stick.

The identifying information storage unit 240 is a memory device such as SRAM. If a certain transfer mode is selected by the mode selection unit 254 as described below, the identifying information storage unit 240 stores the descriptor of the firmware corresponding to the selected transfer mode. This is to notify PC 100 of the firmware corresponding to the selected transfer mode in a more convenient manner when the digital imaging apparatus 200 is connected to PC 100 after selecting the certain transfer mode. Also, the descriptor that is stored in the identifying information storage unit 240 is updated every time the data transfer mode changes by the mode selection unit 254.

The key operation unit 250 comprises a plurality of operation keys (not shown) that outputs a signal to the controlling unit 290 for setting or operating the function supported by the digital imaging apparatus 200. In an embodiment of the present invention, the key operation unit 250 is provided with a display request unit 252 and a mode selection unit 254.

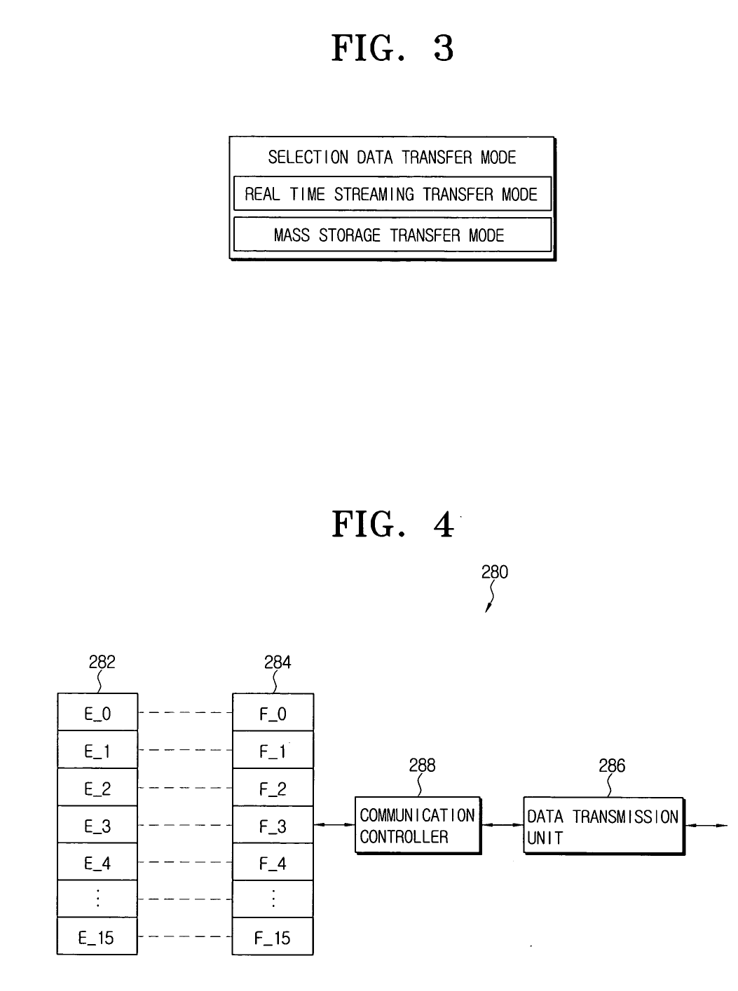

The display request unit 252 outputs a request signal allowing the data transfer mode selection screen shown in FIG. 3 to be displayed. The data transfer mode selection screen is a screen provided to select either one of the real-time streaming mode or the mass storage mode provided by the digital imaging apparatus 200. As one skilled in the art can appreciate, if other modes are additionally provided in addition to the above two transfer modes, the additional transfer mode can also be provided on the screen.

The mode selection unit 254 outputs to the controlling unit 290 a mode selection signal, that selects either the real-time streaming mode or the mass storage mode.

If the display request unit 252 is selected, the display unit 260 displays the data transfer mode selection screen which includes the two modes described above provided by the digital imaging apparatus 200. The display unit 260 also displays messages, images, and other information, that allows a user to input appropriate instructions necessary for controlling the operations of the digital imaging apparatus 200.

The OSD processing unit 270 provides various characters/image information to be displayed on the display unit 260. Preferably, the OSD processing unit 270, if the display request unit 252 of the key operation unit 250 is selected, OSD-processes the data transfer mode selection screen shown in FIG. 3 and provides the processed screen to the display unit 260. Then, the user can select one of the two modes using the mode selection unit 254 or the directional key (not shown) of the key operation unit 250. Hereinafter, a case in which the transfer mode is selected by the mode selection unit 254 will be described.

The USB transmitting module 280 is connected to USB receiving module 160 of PC 100 via the transmission cable 300, and transmits the image data to the USB receiving module 160 at a high data transmission rate. The USB transmitting module 280 can receive also data from the PC 100, but description thereof will be omitted.

FIG. 4 is a schematic block diagram of the USB transmitting module shown in FIG. 1. With reference to FIG. 4, the USB transmitting module 280 comprises an endpoint provision unit 282, a FIFO 284, a data transmission unit 286, and a communication controller 288. The endpoint provision unit 282 has sixteen endpoints (E_0˜E_15). Thereby, the image data to be transmitted to PC 100 is transmitted via temporary storage areas (F_0˜F_15) of FIFO 284 corresponding to each of the endpoints (E_0˜E_15). Of them, a particular endpoint 0 (E_0) is designated for providing an access to configuration, status, and control information of the USB transmitting module 280.

The FIFO 284 is divided into a plurality of the temporary storage areas (F_0˜F_15) corresponding to a plurality of the endpoints (E_0˜E_15), and a given buffer in which the descriptor or the image data corresponding to the transfer mode selected by the mode selection unit 254 is temporarily stored in at least one temporary storage area.

In an embodiment of the present invention, the FIFO 284 is divided into sixteen temporary storage areas (F_0˜F_15) equal to the number of the endpoints (E_0˜E_15) as described in greater below. The descriptor or the image data that is temporarily stored in the FIFO 284 is transmitted to PC 100.

The data transmission unit 286 provides PC 100 with the image data stored in the temporary storage area of the FIFO 284 corresponding to the endpoint selected from the endpoint provision unit 282 under the control of the communication controller 288.

The communication controller 288 selects at least three endpoints out of the plurality of the endpoints, and then sets the transfer type, the transfer direction for transferring the image data, and the packet size of the image data to be temporarily stored in the FIFO 284, for each of the selected endpoints.

The communication controller 288 allows the image data to be temporarily stored in the temporary storage areas of the FIFO 284 corresponding to the selected endpoint, and allows the temporarily stored image data to be transferred to PC 100 according to the transfer type set.

The data transfer mode includes a control transfer mode, an isochronous transfer mode, an interrupt transfer mode, and a bulk transfer mode.

The control transfer mode is duplex transfer, and transmits the information set by the communication controller 288 to PC 100 via the endpoint 0 (E_0). The isochronous transfer mode is usually used to transmit streaming data requiring a constant data transfer rate. The interrupt transfer mode is usually used when polling to check if there is an interrupt to be transferred in case of the amount of data to be transferred being small. The bulk transfer mode is used in case the amount of data to be transferred is large.

The controlling unit 290 controls the general operation of the digital imaging apparatus 200 according to various control programs stored in the main storage unit 220 and a key operation signal corresponding to the key operation unit 250.

The controlling unit 290, controls OSD processing unit 270 and the display unit 260 if the display request unit 252 is selected, such that the OSD menu screen for selecting the data transfer mode as shown in FIG. 3 is displayed.

The controlling unit 290 allows the descriptor of the firmware corresponding to the selected transfer mode to be read out from the firmware storage unit 222 and to be stored in the identifying information storage unit 240 if a certain transfer mode is selected by the operation of the mode selection unit 254. Also, every time the transfer mode is changed by the mode selection unit 254, the controlling unit 290 controls the identifying information storage unit 240 so that the descriptor stored in the identifying information storage unit 240 can be updated.

In addition, when connecting to PC 100 external digital equipment so as to make possible data communications with it, the controlling unit 290 confirms the descriptor of the firmware corresponding to the selected transfer mode stored in the identifying information storage unit 240, and allows the confirmed descriptor to be transmitted to the USB receiving module 160 of PC 100. Then, PC 100 discriminates the descriptor that is transmitted and causes a corresponding driver to be in a driving stand-by state.

If the descriptor of the firmware corresponding to the selected transfer mode is transferred to PC 100 and then the run command for the selected transfer mode is received from PC 100, the controlling unit 290 allows the firmware corresponding to the selected transfer mode to be carried out.

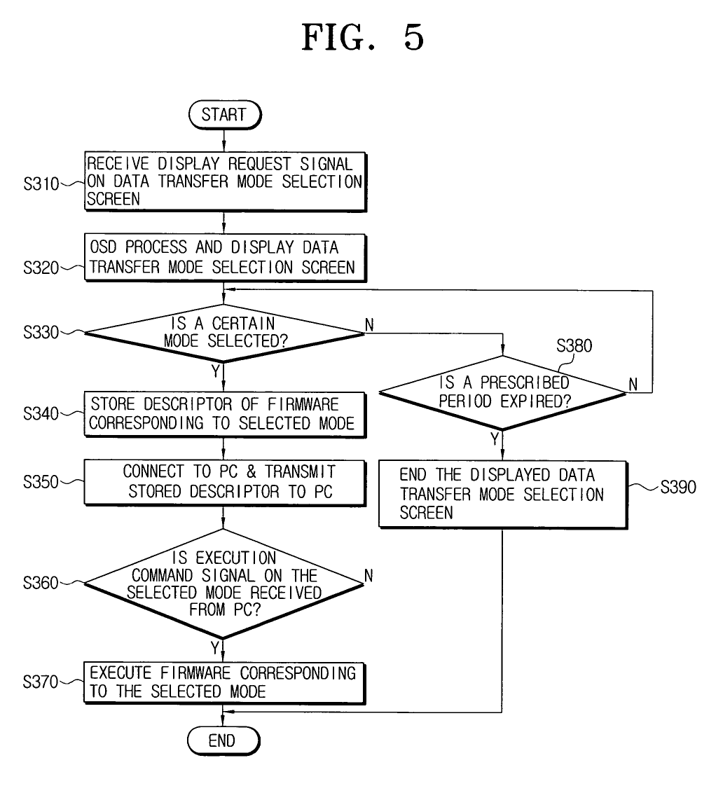

FIG. 5 is a flow chart illustrating a method for data transfer mode selection using the digital imaging apparatus shown in FIG. 1.

With reference to FIGS. 1 through 5, in the data transmission between the digital imaging apparatus 200 supplied with USB communication according to an embodiment of the present invention and PC 100, if the display request unit 252 is selected and the display request signal for the data transfer mode selection screen is received (S310), the controlling unit 290 controls the OSD processing 270 and the display unit 260 so that the data transfer mode selection screen as shown in FIG. 2 can be OSD-processed and the processed screen can be displayed on the display unit 260 (S320).

After the data transfer mode selection screen has been displayed on the display unit 260 in the step 320, if a certain transfer mode of the two transfer modes is selected by the operation of the mode selection unit 254 (“Yes” path from decision step S330), the controlling unit 290 allows the descriptor of the firmware for implementing the selected transfer mode to be stored in the identifying information storage unit 240 (S340). At this time, it is desirable to store only the descriptor of the firmware for the final selected transfer mode in the identifying information storage unit 240. This provides a more accurate descriptor when the digital imaging apparatus 200 provides PC 100 with the descriptor of a given firmware for the selected transfer mode with the connection of the digital imaging apparatus 200 and the PC 100.

In addition, when the transmitting module 280 of the digital imaging apparatus 200 and the USB receiving module 160 of the PC 100 are connected via the transmission cable 300, the controlling unit 290 allows the descriptor of the firmware stored in the identifying information storage unit 240 to be transmitted to the PC 100 (S350).

After step S350, if the execution command signal in the transfer mode selected in step S330 is received from the PC 100 (“Yes” path from decision step S360), the controlling unit 290 allows the firmware corresponding to the selected transfer mode stored in the firmware storage unit 222 to run (S370). In this manner, the real-time image data or the previous stored image data from the digital imaging apparatus 200 is transferred to PC 100.

On the other hand, if no mode is selected in step S330 and a prescribed period is expired (“Yes” path from decision step S380), the data transfer mode selection screen displayed on the display unit 260 in the step S320 ends (S390).

Hereinafter, a detailed description will be made on the operation of the digital imaging apparatus 200 and PC 100 according to the transfer mode selected in the step S330.

If the real-time streaming mode is selected in step S330, the descriptor corresponding to the selected real-time streaming firmware is stored in the identifying information storage unit 240. Along with this, the USB transmitting module 280 sets the communication type, the communication direction, and so on, corresponding to the selected transfer mode under the control of the controlling unit 290.

Specifically, if the real-time streaming mode is selected, the communication controller 288 selects three endpoints (E_0, E_1, E_2) for transferring the image data corresponding to the selected transfer mode. Also, the communication controller 288 sets the communication type, the communication direction, and the packet size for each of the selected endpoints (E_0, E_1, E_2) as Table 1 below.

TABLE I

| Selected | real-time streaming mode | | | mass storage mode | | |
|---|---|---|---|---|---|---|
| endpoint | No. 0 | No. 1 | No. 2 | No. 0 | No. 2 | No. 3 |
| Transfer type | Control | Bulk | Bulk | Control | Bulk | Bulk |
| | transfer | transfer | transfer | transfer | transfer | transfer |
| Transfer | IN/OUT | OUT | IN | IN/OUT | OUT | IN |
| direction | | | | | | |
| Packet size | 8 byte | 64 byte | 64 byte | 8 byte | 64 byte | 64 byte |

In Table 1, in the case of the real-time streaming mode, the communication controller 288 arranges for data to be sent in the control transfer for the endpoint 0 (E_0), and in the bulk transfer for the endpoints 1 and 2 (E_1, E_2). ‘IN/OUT’ refers to duplex communication: ‘IN’ indicates a direction that is received from PC 100, and ‘OUT’ indicates a direction that is transmitted to PC 100.

If the USB transmitting module 280 is set corresponding to the real-time streaming mode of Table 1 and then the digital imaging apparatus 200 and PC 100 are connected, USB host 150 sends a ‘reset signal’ to the digital imaging apparatus 200.

Then, the controlling unit 290 allows the descriptor (shown in FIG. 2B) for the real-time streaming firmware to be read out from the identifying information storage unit 240 and to be stored in a temporary storage area of the FIFO 244. If the descriptor request signal is received from PC 100, the communication controller 288 allows the temporarily stored descriptor as shown in FIG. 2B to be transmitted to PC 100.

USB host 150 extracts IdVendor (information identifying the manufacturer) (VID) and PID from the VID and PID fields of the transmitted descriptor, and loads the corresponding driver. The CPU 130 of PC 100 allows the driver corresponding to the determined firmware identifying information to be in a driving stand-by state.

Subsequently, if the application program for implementing the real-time streaming mode is selected by a given operation key (not shown) mounted on PC 100 and a signal for selecting the application program is received, the camera unit 210 of the digital imaging apparatus 200 begins to acquire image data.

Concurrently, the firmware corresponding to the real-time streaming mode is run by the controlling unit 290 of the digital imaging apparatus 200, and hence the image data that is picked up and signal-processed through the camera unit 210 is transmitted to the PC 100 on a real-time basis. At this time, the image data being transferred to PC 100 is stored in the temporary storage area of the FIFO 284 corresponding to the selected endpoints (E_0, E_2), and then is transferred based on the type set in Table 1. By doing this, the image data that is currently acquired through the digital imaging apparatus 200 is displayed as moving picture on the display device (not shown) of PC 100 in a real-time.

Alternatively, if the mass storage mode is selected in the decision step S330, the descriptor corresponding to the selected mass storage firmware is stored in the identifying information storage unit 240. Along with this, the USB transmitting module 280 sets the communication type, the communication direction, and other information. corresponding to the selected transfer mode under the control of the controlling unit 290.

Specifically, if the mass storage mode is selected, the communication controller 288 selects three endpoints (E_0, E_2, E_3) for transferring the image data corresponding to the selected transfer mode. The communication controller 288 the sets the communication type, the communication direction, and the packet size for each of the selected endpoints (E_0, E_2, E_3) as shown in Table 1.

In Table 1, in the case of the mass storage mode, the communication controller 288 arranges for data to be sent in the control transfer for the endpoint 0 (E_0) and in the bulk transfer for the endpoints 2 and 3 (E_2, E_3).

If the USB transmitting module 280 is set corresponding to the mass storage mode of Table 1 and then the digital imaging apparatus 200 and PC 100 are connected, the USB host 150 sends ‘reset signal’ to the digital imaging apparatus 200.

Then, the controlling unit 290 allows the descriptor (shown in FIG. 2C) for the mass storage firmware to be read out from the identifying information storage unit 240 and to be stored in a temporary storage area of the FIFO 284. If the descriptor request signal is received from the PC 100, the communication controller 288 allows the temporarily stored descriptor as shown in FIG. 2C to be transmitted to PC 100.

The USB host 150 extracts and confirms VID and PID information from VID field and PID field of the transmitted descriptor, and loads the corresponding driver. The CPU 130 of PC 100 allows the driver corresponding to the confirmed firmware descriptor to be set in a driving stand-by state.

Subsequently, if the window explorer for implementing the mass storage mode is selected by a given operation key (not shown) mounted on the PC 100, the PC 100 recognizes the sub storage unit 230 of the digital imaging apparatus 200 as a movable disc.

Accordingly, if the PC 100 accesses and selects a given file stored in the sub-storage unit 230 of the digital imaging apparatus 200 using the window explorer, the firmware corresponding to the mass storage mode is run by the controlling unit 290 of the digital imaging apparatus 200, and the file selected by PC 100 is transmitted to the PC 100. At this time, the image data being transmitted to PC 100 is temporarily stored in the temporary storage area of the FIFO 284 corresponding to the selected endpoints (E_0, E_2), and then is sent based on the type set in Table 1.

Thus, at least one file stored in the sub storage unit 230 is sent to, and stored in, the storage medium such HDD 140, and hence it is possible to carry out playback, edit, and the like on the stored file by using image editing software.

As described above, in the case when the digital imaging apparatus 200 with USB communication supports both the real-time streaming mode and the mass storage mode, by selecting a certain transfer mode for executing (i.e., a given firmware) before being connected to the PC 100 and notifying the PC 100 of the descriptor thereof, the PC 100 allows the driver corresponding to the selected firmware to be in a driving stand-by state. Therefore, if the run command for the selected transfer mode is received from PC 100, the digital imaging apparatus 200 can execute the firmware corresponding to the selected transfer mode in an easier manner.

In addition, in the case of having three or more image data transfer modes, it is desirable that the descriptor corresponding to each of the transfer modes is stored in each of the firmware storage unit 222. Also, the setting of the endpoint for each of the transfer mode can be varied according to development environment such as the hardware of the digital imaging apparatus 200 or PC 100.

Alternatively, the digital imaging apparatus 200 described above can select the data transfer mode selection screen as shown in FIGS. 2A through 2C, and also the transfer mode by the operation of a prescribed operation key (not shown), or switch (not shown), or other device. mounted on the body of the digital imaging apparatus 200. Also, in the case where the digital imaging apparatus 200 is provided with a light-receiving unit (not shown) capable of receiving the optical signal such as infrared ray signal, it is natural that the digital imaging apparatus 200 can select the transfer mode by the external adjustment device such as a remote controller (not shown).

As described above, with the digital imaging apparatus and the method for selecting data transfer mode thereof according to the embodiments of the present invention, it is possible to communicate with an external digital device efficiently by selecting in advance one among at least two modes wherein the image data being currently picked up is sent in either a real-time basis or in another mode, wherein the previously stored image data is sent, and then connecting to the external digital device such as PC via USB interface.

Although various embodiments of the present invention have been disclosed and described with reference to the appended drawings, such descriptions in the present specification are only for illustrative purposes, and not meant for limiting the embodiments of the present invention.

Also, those who are skilled in the art will appreciate that various modifications, additions and substitutions are possible without departing from the scope and spirit of the present invention. Therefore, it should be understood that the present invention is limited only to the accompanying claims and the equivalents thereof, and includes the aforementioned modifications, additions and substitutions.

What is claimed is:

1. A digital imaging apparatus comprising:
a main storage unit for storing a firmware for at least two data transfer modes for transmitting image data acquired through a camera to an external device in different manners, respectively, and also for storing a descriptor including information for identifying the firmware;
a mode selection unit for outputting a mode selection signal for a certain transfer mode for the at least two data transfer modes;
a transmitting module for connecting to the external device to transmit the image data to the external device, the transmitting module sending the image data in different data transfer manners for each data transfer mode; and
a controlling unit which controls the transmitting module so as to set the transfer manner corresponding to the selected certain transfer mode if the mode selection signal is received from the mode selection unit, and reads out descriptor of firmware corresponding to the selected transfer mode from the main storage unit and provides the descriptor to the transmitting module if the transmitting module is connected to the external device,
wherein the controlling unit allows the read descriptor of the firmware to transmit if a transfer allowance command is received from the external device.

2. The apparatus of claim 1, further comprising a sub-storage unit for storing the image data picked up through the camera,
wherein the at least two data transfer modes include a first mode wherein the image data being currently acquired through the camera is transmitted to the external device in a real-time data stream, and a second mode wherein the image data stored in the sub-storage unit is transmitted to the external device, the main storage unit storing each of the firmware corresponding to the first mode and the second mode and the identifying information.

3. The apparatus of claim 2, further comprising
an on screen display (OSD) processing unit for OSD-processing a data transfer mode selection screen for selecting the certain transfer mode of the first mode and the second mode, and outputs the result of the processing;
a display unit for displaying the OSD processed data transfer mode selection screen; and
a display request unit for generating a display request signal on the data transfer mode selection screen,
wherein if the display request signal is received from the display request unit, the controlling unit OSD-processes and displays the data transfer mode selection screen on the display unit, and receives the mode selection signal for the transfer mode selected by the mode selection unit at the displayed data transfer mode selection screen.

4. The apparatus of claim 3, wherein the transmitting module comprises:
a first-in first-out (FIFO) which is divided into a plurality of temporary storage areas, and the image data for sending to the external device and the descriptor corresponding to the selected transfer mode are temporarily stored in at least one of the temporary storage areas;
a provision unit for providing a plurality of endpoints corresponding to the plurality of temporary storage areas; and
a communication controller that selects at least three endpoints out of the plurality of the endpoints and sets the transfer manner for transferring the image data for each of the selected endpoints, and that allows the image data temporarily stored in the temporary storage areas corresponding to the selected endpoint to be sent to the external device according to the transfer type set.

5. The apparatus of claim 4, wherein if the first mode is selected by the mode selection unit, the communication controller selects endpoint numbers 0 to 2 among the plurality of endpoints, and if the second mode is selected by the mode selection unit, the communication controller selects endpoints numbers 0, 2, and 3 among the plurality of endpoints, and setting the transfer manner for each of the selected endpoints.

6. The apparatus of claim 1, wherein the transmitting module is a universal serial bus interface, and the identifying information of the firmware is stored in the location of offset 10 of the descriptor in the size of two data bytes.

7. The apparatus of claim 2, wherein if the external device and the transmitting module are connected with each other, the sub storage unit is recognized as an accessible movable disc in the external device.

8. A method for selecting data transfer mode of a digital imaging apparatus comprising the steps of:
storing image data being acquired through a camera;
selecting a certain mode of at least two modes for transferring the image data acquired through the camera to an external device in different manners;
connecting to the external device via a transmitting module so as to communicate with the external device after the certain transfer mode is selected;
receiving a transfer allowance command on a descriptor from the external device; and
transferring the descriptor including identifying information of firmware corresponding to the selected transfer mode to the external device.

9. The method of claim 8, wherein each of the firmware for the at least two transfer modes and each of the descriptors including the identifying information of the firmware are stored, respectively, the identifying information being stored in the location of offset 10 of the descriptor in the size of two data bytes.

10. The method of claim 8, prior to the step of selecting the certain transfer mode, further comprising the steps of:
generating a display request command for a data transfer mode selection screen selectable the certain transfer mode of the at least two modes; and
if the display request command is generated, on screen display (OSD)-processing the data transfer mode selection screen, thereby displaying the OSD-processed data transfer mode selection screen,
wherein the step of selecting the certain transfer mode selects the certain transfer mode from the OSD-processed data transfer mode selection screen.

11. The method of claim 8, wherein the at least two data transfer modes includes a first mode wherein the image data being currently acquired through the camera is transferred to the external device in a real-time data stream, and a second mode wherein the image data stored in the storage step is transferred to the external device, the firmware and the descriptor corresponding to the first mode and the second mode being stored, respectively.

12. The method of claim 11, after the step of selecting the certain transfer mode, further comprising the steps of:
selecting at least three endpoints for transferring image data corresponding to the selected transfer mode;
setting a transfer type for transferring the image data for each of the selected three endpoints;
after connecting to the external device, transferring the descriptor corresponding to the selected transfer mode to the external device;
receiving a run command on the selected transfer mode from the external device;
dividing the image data into a prescribed packet size and temporarily storing the divided image data in three temporary storage areas corresponding to the selected three endpoints; and
transferring the temporarily stored image data to the external device according to the set transfer type.

13. The method of claim 12, wherein, in the endpoint selection step, if the first mode is selected in the mode selection step, endpoints numbers 0 to 2 are selected; and if the second mode is selected, endpoints numbers 0, 2 and 3 are selected.

14. The method of claim 8 wherein the transmitting module is a universal serial bus interface.

15. A digital imaging apparatus for transferring image data being acquired through a camera to external device connected via a transmitting module, comprising:
a sub-storage unit for storing the image data being acquired through the camera;
a main storage unit for storing a firmware for a first mode wherein the image data being currently acquired through the camera is sent to the external device in a real-time stream and a firmware for a second mode wherein the image data stored in the sub-storage unit is sent to the external device;
a mode selection unit for applying a mode selection signal for a certain transfer mode of the first mode and the second mode; and
a controlling unit that allows identifying information of firmware corresponding to the selected certain mode to be transferred to the external device, if the mode selection signal is received from the mode selection unit and the transmitting module is connected to the external device.

16. The apparatus of claim 15, further comprising:
an on screen display (OSD) processing unit for OSD-processing a data transfer mode selection screen for selecting the certain transfer mode of the first mode and the second mode and outputs the result of processing;
a display unit for displaying the OSD-processed data transfer mode selection screen; and
a display request unit for generating a display request signal on the data transfer mode selection screen,
wherein if the display request signal is received from the display request unit, the controlling unit OSD-processes and displays the data transfer mode selection screen on the display unit, and the mode selection unit outputs the mode selection signal to the controlling unit by selecting the certain mode of the data transfer mode selection screen displayed on the display unit.

17. The apparatus of claim 15, wherein the transmitting module is applied with a universal serial bus interface.

18. The apparatus of claim 15, wherein if the identifying information of the firmware is transferred to the external device and the execution command for the selected certain mode is received from the external device, the controlling unit allows the firmware corresponding to the selected certain mode to be executed.

19. The apparatus of claim 15, wherein if the external device and the transmitting module are connected with each other, the sub-storage unit is recognized as an accessible movable disc in the external device.

20. A method for selecting data transfer mode of a digital imaging apparatus transferring image data being acquired through a camera to an external device connected via a transmitting module comprising the steps of:
storing the image data being acquired through the camera;
selecting a certain mode among a first mode wherein the image data being currently picked up through the camera is send to the external device in a real-time data streaming and a second mode wherein the image data that is stored in advance is send to the external device; and
if the certain mode is selected and the external device and the transmitting module are connected with each other to perform data communication, transferring the identifying information of firmware corresponding to the selected certain mode to the external device.

21. The method of claim 20, wherein, prior to the step of selecting the certain mode, further comprising the steps of:
generating a display request command for a data transfer mode selection screen selectable the certain mode of the first mode and the second mode; and
if the display request command is generated, on screen display (OSD)-processing the data transfer mode selection screen, thereby displaying the OSD-processed data transfer mode selection screen,
wherein the step of selecting the certain mode selects the certain mode from the OSD-processed data transfer mode selection screen.

22. The method of claim 20, wherein the transmitting module is applied with a universal serial bus interface.

23. The method of claim 20, further comprising the step of:
after the step of transferring the identifying information of the firmware to the external device, receiving the execution command for the selected certain mode from the external device; and
executing firmware corresponding to the selected certain mode.
